(19) United States
(12) Patent Application Publication
(10) Pub. No.: US 2005/0202762 A1
(43) Pub. Date: Sep. 15, 2005

(54) Dresser for polishing cloth and method for producing the same

(75) Inventor: Tadakatsu Nabeya, Kamakura-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: READ CO., LTD., Yokohama-shi (JP)

(21) Appl. No.: 11/073,619

(22) Filed: Mar. 8, 2005

(30) Foreign Application Priority Data
Mar. 10, 2004 (JP) 2004-068135

(51) Int. Cl. B24B 1/00; B32B 9/04

(52) U.S. Cl. 451/56; 428/446

(57) ABSTRACT

To provide a dresser for a polishing cloth in which a stable dressing performance is maintained, a uniformly polished surface is provided on the surface of the polishing cloth, and in particular, a scratch on a wafer caused by the dissociation of abrasive grains is prevented, and a method for producing the same

A dresser for a polishing cloth includes a base 1 and a dressing part disposed on the surface of the base. The dressing part includes a plurality of abrasive grains 2 and a plate-shaped holding component 3 that holds the abrasive grains 2. The holding component 3 is composed of cemented carbide, cermet, or ceramic. Alternatively, the holding component 3 may be composed of a material containing silicon to which silicon dioxide is added. A method for producing the dresser for a polishing cloth includes a step of forming adhesive portions having almost the same diameter as that of the abrasive grains at positions corresponding to holding positions of the abrasive grains 2 to be arrayed with regularity, the positions being disposed on the surface of the holding component or a sheet disposed on the holding component; adhering the abrasive grains 2 on the adhesive portions; and sintering the holding component 3 to fix the abrasive grains 2.

### TECHNICAL FIELD

The present invention relates to a dresser for a polishing cloth, the dresser being used for removing the clogging or contamination on the polishing cloth in chemical and mechanical polishing (hereinafter abbreviated to CMP), thereby regenerating the surface of the polishing cloth to recover the polishing rate, and a method for producing the same.

### BACKGROUND ART

A CMP process is generally used in the production process of highly integrated electronic circuits such as an integrated circuit in order to planarize elevated portions or to remove surface defects such as crystal lattice defects, scratches, or the roughness of a conductive layer, a dielectric layer, and an insulating layer formed on the surface of a substrate or a wafer. In such a CMP process, the wafer is pressed on a polishing cloth with a predetermined load, the polishing cloth being composed of, for example, a foamed polyurethane and applied on a disc-shaped platen. The polishing is performed by rotating both the wafer and the polishing cloth, while a polishing solution called chemical slurry is supplied.

Examples of the chemical slurry used in the CMP process include polishing solutions in which polishing particles composed of, for example, iron oxide, barium carbonate, cerium oxide, aluminum oxide, or colloidal silica are suspended in a solution of, for example, potassium hydroxide, diluted hydrochloric acid, diluted nitric acid, hydrogen peroxide, or iron nitrate. The chemical slurry is selected according to, for example, the polishing rate and the kind of the substance on the wafer to be polished.

This CMP process is repeated many times in the steps of laminating various electronic circuits on the substrate or the wafer. Consequently, as the number of times of the CMP increases, for example, polishing particles or polished chips enter minute holes on the polishing cloth to clog the holes. This phenomenon decreases the polishing rate. Therefore, an operation called dressing must be performed constantly or periodically in order to remove the clogging of the polishing cloth, thereby regenerating the surface to recover the polishing rate. A tool called a dresser for a CMP polishing cloth is used in such an operation.

The dresser for a CMP polishing cloth includes a surface for dressing the polishing cloth, the surface having abrasive grains thereon. Diamond is an excellent material when used as the abrasive grains on the surface. Accordingly, dressers for a CMP polishing cloth using diamond abrasive grains have been developed. For example, a method for electrocoating diamond abrasive grains on a stainless steel by nickel plating is proposed and is in practical use. In addition, a method for brazing diamond abrasive grains on a stainless steel using a metal brazing material (Japanese Unexamined Patent Application Publication No. 10-12579) and a method for arraying diamond abrasive grains on substantially concentric circles at approximately even intervals (Japanese Unexamined Patent Application Publication No. 2000-141204) are proposed.

According to the known dressers for a polishing cloth, the abrasive grains are held by nickel plating or by brazing using, for example, a brazing material mainly composed of Cu or Ni. The abrasive grains are mechanically held with a metal, namely, Ni or Cu serving as a holding component.

In the above methods for holding abrasive grains using plating or a brazing material, it is difficult to produce a dresser in which the amount of embedding of abrasive grains is uniform. When the amount of embedding of abrasive grains is insufficient, the abrasive grains may be dissociated during the dressing of a polishing cloth. In addition, when the amount of projection of the abrasive grains is not uniform, the dressing rate becomes insufficient or the surface state of the polishing cloth is varied. Furthermore, in some cases, an excessive load that would cause a slight plastic deformation of the metal serving as the holding component is applied on an abrasive grain. In such a case, a space is formed between the abrasive grain and the holding component. As a result, the abrasive grain is dissociated from the dresser.

In addition, synthetic diamond is used in the known dressers for a polishing cloth. In the synthesis of such diamond, a metal such as Co or Ni is used as a catalyst and the catalytic metal is contained in the diamond. Therefore, when such diamond is used as abrasive grains, the catalytic metal serves as a base point to break the diamond. Consequently, the diamond is dissociated from a dresser. In other words, since heat is applied during the production of the dresser, the catalytic metal in the diamond serves as a base point to generate a minute crack in the diamond because of the difference in the coefficient of thermal expansion between the diamond and the catalytic metal. The crack may cause the dissociation of the diamond during the dressing of the polishing cloth. The diamond dissociated from the dresser may generate a large scratch on the wafer.

According to the known dressers for a polishing cloth, abrasive grains composed of, for example, diamond are disposed at random or arranged on substantially concentric circles at approximately even intervals. In any case, however, the intervals between the abrasive grains are not even as a whole operating surface of the dresser for a polishing cloth. Therefore, the dresser cannot achieve a stable dressing performance and a uniformly polished surface of the polishing cloth cannot be provided.

For example, at a place where the intervals between the abrasive grains are small, chips of the polishing cloth generated by the grinding or polishing particles clogged in the polishing cloth are not discharged to the outside but adhered between the abrasive grains. Alternatively, a part of the polishing cloth is adhered between the abrasive grains by the frictional heat during the grinding, thereby causing clogging. In such a case, the grinding performance of the dresser is impaired and a semi-mirror surface is provided on the surface of the polishing cloth. As a result, the polishing rate is decreased.

According to the known dressers for a polishing cloth, since a metal such as Cu or Ni is used as the holding component that holds diamond, the metal of the holding component may be dissolved depending on the kind of slurry used in the dressing of the polishing cloth. As a result, the wafer is contaminated. When such dissolution occurs, the amount of holding component that holds abrasive grains becomes insufficient and the abrasive grains may be dissociated. Accordingly, in order to solve the problem, an acid and alkali-resistant nonmetal film may be coated on the surface of the holding component. However, in order to perform such a coating, the holding component must be heated at several hundreds of degrees. When a metal such as Cu or Ni is used as the holding component, the metal is deformed because of the heat. In such a case, the flatness of the surface having the abrasive grains is deteriorated. As a result, since the abrasive grains are partially in contact with the polishing cloth, uniform dressing cannot be performed.

### SUMMARY OF THE INVENTION

The technical problem to be solved by the present invention is to provide the following dresser for a polishing cloth and a method for producing the same. According to the dresser for a polishing cloth, a scratch on a wafer caused by the dissociation of abrasive grains is prevented, a stable dressing performance of the dresser for a polishing cloth is maintained, a uniformly polished surface is provided on the surface of the polishing cloth, the polishing of the wafer with the polishing cloth is performed at a constant polishing rate, and the dresser can be used with all kinds of slurry.

In order to solve the above problem, a dresser for a polishing cloth according to the present invention includes a base and a dressing part disposed on the surface of the base, wherein the dressing part includes a plurality of abrasive grains and a plate-shaped holding component that holds the abrasive grains. In the dresser for a polishing cloth, the holding component is mainly composed of cemented carbide or cermet composed of at least one substance having a high melting point and a high hardness selected from a transition metal of IVa, Va, or VIa group of the periodic law, oxide, carbide, nitride, boride, and a composite thereof and at least one metal phase selected from Fe, Co, Ni, Cu, Ti, Cr, and Ag; or a ceramic composed of at least one substance selected from oxide, carbide, nitride, and boride. When a holding component is composed of a brazing material mainly composed of Cu or Ni or plated Ni, abrasive grains may be dissociated with a load applied thereon. In contrast, according to the holding component mainly composed of the above substance having a high melting point and a high hardness such as the cemented carbide, the cermet, or the ceramic, even when the load that would cause such a dissociation is applied, the holding component is not deformed and the abrasive grains can be mechanically held with a strong force. Therefore, a scratch on a wafer due to the dissociation of the abrasive grains can be prevented. In order to modify the cemented carbide, the cermet, or the ceramic, a small amount of additives may be added to the holding component.

Specifically, the cemented carbide used in the holding component preferably includes tungsten carbide-cobalt (WC—Co), the cermet used in the holding component preferably includes titanium carbide-nickel (TiC—Ni), and the ceramic used in the holding component preferably includes silicon carbide (SiC) and silicon nitride (Si₃N₄).

In order to solve the above problem, another dresser for a polishing cloth according to the present invention includes a base and a dressing part disposed on the surface of the base, wherein the dressing part includes a plurality of abrasive grains and a plate-shaped holding component that holds the abrasive grains. In the dresser for a polishing cloth, the holding component includes silicon serving as a main component; at least one substance serving as a main component selected from a transition metal of IVa, Va, or VIa group of the periodic law, oxide, carbide, nitride, boride, and a composite thereof; and silicon dioxide serving as flux.

The amount of silicon dioxide is preferably 1% to 6%, more preferably, 3% to 5% of the weight of the holding component. Silicon dioxide added in this range serves as flux that decreases the sintering temperature of the holding component. When the amount of silicon dioxide is in the above range, the sintering temperature is specifically decreased. When the amount of silicon dioxide is less than 1% or exceeds 6%, the sintering temperature is higher than that in the above case. In particular, examples of the transition metal of IVa, Va, or VIa group of the periodic law preferably include tungsten.

The abrasive grains are normally held with the holding component only mechanically. The coating on the surfaces of the abrasive grains with a transition metal of IVa, IVb, Va, or VIa group improves the wettability with the holding component and generates a chemical force for holding the abrasive grains. When the coating material is chemically bonded with the abrasive grains to form a compound composed of the coating material and the abrasive grains at the interface thereof, the chemical force for holding the abrasive grains is increased to suppress the dissociation of the abrasive grains.

The coating on the surfaces of the abrasive grains can also prevent the abrasive grains from chipping during the dressing of the polishing cloth. This is assumed to be based on the following advantages: The coating prevents the heat from being conducted to the inside of the abrasive grains. Alternatively, distortion in the inside of the abrasive grains is released by the coating process or the coating itself. The amount of coating on the surfaces of the abrasive grains is preferably 1 to 80 weight percent. When the amount of the coating is less than 1 weight percent, entire surfaces of the abrasive grains are not coated and some parts of the abrasive grains may be exposed. When the amount of the coating exceeds 80 weight percent, the content of the metal is excessive. As a result, the diameter of the abrasive grains that contribute to the dressing of the polishing cloth becomes small. However, when the dressing of the polishing cloth is performed under mild processing conditions, the dressing can be performed without such a coating on the abrasive grains.

The amount of projection of the abrasive grains is preferably 10% to 70% of the diameter of the abrasive grains. When the amount of projection is less than 10%, the amount of grinding by the abrasive grains is insufficient to form a mirror surface of the polishing cloth. When the amount of projection exceeds 70%, the abrasive grains are dissociated from the holding component or the dressing rate is excessively increased.

The abrasive grains are preferably composed of diamond or cubic boron nitride having a diameter of 10 to 1,000 μm.

In the known dresser for a polishing cloth, abrasive grains composed of, for example, diamond are disposed at random. Alternatively, although the abrasive grains are disposed on substantially concentric circles at approximately even intervals, the intervals between the abrasive grains are not even. Accordingly, a uniformly dressed surface on the polishing cloth cannot be provided and the polishing rate cannot be arbitrary controlled. At a place where the intervals between the abrasive grains are small, since polished chips of the polishing cloth and polishing particles are not satisfactorily discharged, these polished chips and polishing particles are clogged in the dresser. As a result, stress is intensively applied on the clogged portions and abrasive grains are dissociated from the holding component. Consequently, a scratch, which is fatal damage, is generated on the surface of a wafer. According to the present invention, the abrasive grains are arrayed two-dimensionally, and in addition, the intervals between the abrasive grains and the grain size of the abrasive grains are controlled. As a result, a uniform surface and a constant polishing rate suitable for CMP conditions can be provided. According to the dresser for a polishing cloth of the present invention, the abrasive grains are composed of a group having a predetermined grain size or two or more of groups having different predetermined grain size, and abrasive grains in each group are two-dimensionally arrayed with independent regularity. The distance between the adjacent abrasive grains on the minimum grid formed by the array is in the range of 10 to 3,000 μm, and the abrasive grains are substantially arrayed with an even distribution.

In the dresser for a polishing cloth according to the present invention, an acid and alkali-resistant nonmetal film having a low coefficient of friction may be disposed on the exposed surface of the holding component. In addition to the exposed surface of the holding component, the nonmetal film is preferably disposed on the exposed surface of the base that holds the holding component.

The acid and alkali-resistant nonmetal film preferably has a thickness of 1 to 10 μm. Specifically, the acid and alkali-resistant nonmetal film is preferably composed of a halogen-containing diamond like carbon or diamond like carbon.

The coating of such an acid and alkali-resistant nonmetal film was invented in order to solve the following problem: In the known dresser for a polishing cloth, since a metal such as Cu or Ni is used as the holding component that holds diamond, the metal of the holding component may be dissolved depending on the kind of slurry used in the dressing of the polishing cloth. As a result, the wafer is contaminated. The above coating can be applied to the known dresser on which the abrasive grains are fixed by brazing or electrocoating. However, since the processing temperature required for the coating is several hundreds of degrees, a metal such as Ni is deformed. In such a case, the flatness of the surface having the abrasive grains is deteriorated. This phenomenon causes a variation in the polishing performance between individual dressers. According to the dresser for a polishing cloth of the present invention, the holding component is mainly composed of cemented carbide, cermet, or ceramic that is not deformed at such a temperature of several hundreds of degrees. Therefore, even when the coating treatment is performed on the surface, the same polishing performance as that before the treatment can be maintained.

In order to solve the above problem, the present invention provides a method for producing a dresser for a polishing cloth including a base and a dressing part disposed on the surface of the base, wherein the dressing part includes a plurality of abrasive grains and a plate-shaped holding component that holds the abrasive grains, and the holding component is mainly composed of cemented carbide or cermet composed of at least one substance having a high melting point and a high hardness selected from a transition metal of IVa, Va, or VIa group of the periodic law, oxide, carbide, nitride, boride, and a composite thereof and at least one metal phase selected from Fe, Co, Ni, Cu, Ti, Cr, and Ag; or a ceramic composed of at least one substance selected from oxide, carbide, nitride, and boride. The method includes a step of forming adhesive portions having almost the same diameter as that of abrasive grains at positions corresponding to holding positions of the abrasive grains to be arrayed with two-dimensional regularity, the positions being disposed on the surface of the holding component or a sheet disposed on the holding component, in order that the plurality of the abrasive grains are held on the surface of the holding component with regularity; adhering each single particle of the abrasive grains on the adhesive portions; holding the abrasive grains on the surface of the holding component; and sintering the holding component to fix the abrasive grains.

In order to solve the above problem, the present invention provides a method for producing a dresser for a polishing cloth including a base and a dressing part disposed on the surface of the base, wherein the dressing part includes a plurality of abrasive grains and a plate-shaped holding component that holds the abrasive grains, and the holding component includes silicon serving as a main component; at least one substance serving as a main component selected from a transition metal of IVa, Va, or VIa group of the periodic law, oxide, carbide, nitride, boride, and a composite thereof; and silicon dioxide serving as flux. The method in which the plurality of the abrasive grains are held on the surface of the holding component with regularity includes a step of forming adhesive portions having almost the same diameter as that of abrasive grains at positions corresponding to holding positions of the abrasive grains to be arrayed with two-dimensional regularity, the positions being disposed on the surface of the holding component or a sheet disposed on the holding component; adhering each single particle of the abrasive grains on the adhesive portions; holding the abrasive grains on the surface of the holding component; and sintering the holding component to fix the abrasive grains on the holding component. According to this method, the sintering temperature of the holding component can be decreased.

In the above methods, the abrasive grains may be coated with a substance selected from a transition metal of IVa, IVb, Va, or VIa group; Ni, Co, Ag, and Cu; and a compound thereof. The abrasive grains are not necessarily coated with the substance.

In the above methods for arraying, the step of forming the adhesive portions having almost the same diameter as that of the abrasive grains may include a step of forming non-masking portions serving as the adhesive portions on a sheet that masks the surface of the holding component having an adhesive thereon by forming holes having almost the same diameter as that of the abrasive grains.

Subsequently, according to the application, an acid and alkali-resistant nonmetal film may be formed on the top face and side faces of the holding component.

According to the dresser for a polishing cloth having the above configuration and the method for producing the same, the use of the above-described holding component can significantly increase the mechanical holding power of the abrasive grains. The coating on the surfaces of the abrasive grains can further improve the holding power of the abrasive grains and the strength against chipping of the abrasive grains. Furthermore, the abrasive grains composed of, for example, diamond are arrayed with regularity at an appropriate interval. Accordingly, the dresser for a polishing cloth can maintain a stable dressing performance to provide a dressed surface of the polishing cloth having an even surface roughness. As a result, polishing can be stably performed at a constant polishing rate. Furthermore, the interval between the abrasive grains composed of, for example, diamond disposed with regularity is adequately controlled to provide an appropriate surface state of the dresser for the polishing cloth, depending on a work piece to be processed. As a result, the dressing efficiency can be arbitrarily controlled. In addition, the dresser can also be used in acid and alkali-resistant applications by selecting the holding component appropriately. Furthermore, the formation of the acid and alkali-resistant nonmetal film on the top face and the side faces of the holding component allows the dresser to be used in any environment.

### ADVANTAGES

According to the dresser for a polishing cloth in the present invention and the method for producing the same, the dresser for a polishing cloth can maintain a stable dressing performance without generating the dissociation of abrasive grains during the process. As a result, a uniformly dressed surface can be formed on the surface of the polishing cloth and a constant polishing rate can be provided. In addition, according to the dresser of the present invention, the interval between the abrasive grains disposed with regularity is adequately controlled to provide an appropriate surface state of the dresser for the polishing cloth, depending on a work piece to be processed. As a result, the dressing efficiency can be arbitrarily controlled. The present invention can provide the above dresser for a polishing cloth and a simple method for producing the same.

### BEST MODE FOR CARRYING OUT THE INVENTION

FIGS. 1 and 2 show an embodiment of a dresser for a polishing cloth according to the present invention. FIG. 1 shows the overall structure of the dresser. FIG. 2 is a cross-sectional view of the dresser shown in FIG. 1, cut along a plane including the central axis of rotation. The dresser for a polishing cloth includes a cup-shaped base 1 composed of, for example, a metal, a ceramic, or a plastic. A planar holding component 3 that holds a plurality of abrasive grains 2 is fixed with an adhesive 4 on the surface of the base 1, the surface being orthogonal to the axis of rotation. The surface forms an operating surface of the dresser.

Preferable examples of the abrasive grains 2 include abrasive grains composed of diamond or cubic boron nitride coated with a substance selected from a transition metal of IVa, IVb, Va, or VIa group; Ni, Co, Ag, and Cu; and a compound thereof. The abrasive grains 2 are not limited to the above. The abrasive grains 2 composed of, for example, diamond are classified so as to have a predetermined range. Although such classified abrasive grains 2 are used, the grain size is not particularly limited. In general, however, the abrasive grains preferably have a grain size of #325/#400 to #30/#40, which is specified in JIS B4130. When the grain size is less than #325/#400, the amount of projection of the abrasive grains from the dressing surface is not sufficient. In such a case, a satisfactory dressing of the polishing cloth cannot be performed, or the abrasive grains are dissociated because the holding power of the abrasive grains is not sufficient. Such a dissociation of the abrasive grains causes a scratch on a wafer. When the grain size exceeds #30/#40, the polishing cloth is roughened during the dressing. Furthermore, the uniformity on the surface of the wafer is deteriorated. Since the removal speed of the polishing cloth is excessively high, the consumption of polishing cloth is increased. This is not economical.

Examples of the holding component 3 include a sintered compact mainly composed of cemented carbide or cermet composed of at least one substance selected from a transition metal of IVa, Va, or VIa group of the periodic law, oxide, carbide, nitride, boride, and a composite thereof and at least one metal selected from Fe, Co, Ni, Cu, Ti, Cr, and Ag; or a ceramic composed of at least one substance selected from oxide, carbide, nitride, and boride.

Examples of the holding component further include a sintered compact composed of silicon serving as a main component; at least one substance serving as a main component selected from a transition metal of IVa, Va, or VIa group of the periodic law, oxide, carbide, nitride, boride, and a composite thereof; and silicon dioxide serving as flux. Examples of the transition metal of IVa, Va, or VIa group include Ti, Cr, and W. In particular, tungsten is preferably used.

Each particle of the abrasive grains 2 is arrayed and fixed on the surface of the holding component 3 with two-dimensional regularity. The distance between adjacent abrasive grains 2 in the minimum grid formed by the array is preferably in the range of 10 to 3,000 μm. More preferably, the grain size of the abrasive grains 2 is #170 to #60, the distance between the abrasive grains is in the range of 100 to 2,000 μm, and each of the abrasive grains 2 is substantially disposed evenly. Increasing the interval between the abrasive grains 2 increases the polishing rate of a pad and the wafer, roughens the surface roughness of the polishing cloth, and deteriorates the flatness of the wafer. In contrast, reducing the interval between the abrasive grains 2 decreases the polishing rate of the pad and the wafer, planarizes the surface roughness of the polishing cloth, and improves the flatness of the wafer.

When the interval between the abrasive grains 2 is less than 10 μm, ground layers of the polishing cloth and polishing particles are clogged in the dresser. This clogging prevents the polishing cloth from being ground evenly. On the other hand, when the interval between the abrasive grains 2 exceeds 3,000 μm, a satisfactory grinding function cannot be achieved. Therefore, the interval between the abrasive grains is adequately selected according to the kind of the object to be ground and economical efficiency. For example, the surface roughness of the polishing cloth and the polishing rate can be arbitrarily adjusted by controlling the interval.

The arrangement of the abrasive grains 2 will now be described more specifically. In general, the minimum grid formed by adjacent abrasive grains 2 in the circumferential direction and in the radial direction on the base 1 (see FIG. 1) forms a square or a parallelogram (this can also be represented as a triangle). The distance between the adjacent nearest abrasive grains 2 in the minimum grid is in the range of 10 to 3,000 μm. Although the shape of the grid is not limited to the above, each abrasive grain must be arrayed with two-dimensional regularity.

The dresser for a polishing cloth can be readily produced by the following method. Firstly, a plurality of abrasive grains 2 is held on the surface of the planar holding component 3, which is attached to the dresser for a polishing cloth, with two-dimensional regularity. Preferably, adhesive portions having almost the same dimension as the diameter of the abrasive grains are provided on the surface of the holding component 3 directly or on the surface of a sheet disposed on the holding component 3. The adhesive portions are provided at positions corresponding to the holding positions of the abrasive grains 2 to be arrayed with regularity. The abrasive grains 2 are adhered to be fixed on the adhesive portions.

The adhesive portions can be formed as non-masking portions provided on the sheet that masks the holding component 3. In such a case, preferably, a sheet including a plurality of holes having the same diameter as that of the abrasive grains is applied on the holding component 3 having an adhesive thereon. The adhesive portions are formed as the non-masking portions composed of the large number of holes. Alternatively, the adhesive portions may be formed by partially applying an adhesive using, for example, a printing technique. The dimension of the adhesive portions is almost the same as the diameter of the abrasive grains so that the single particle of the abrasive grains 2 is adhered to be fixed. The arrangement of the adhesive portions must have two-dimensionally even intervals corresponding to the holding positions of the abrasive grains 2.

The abrasive grains 2 can be fixed on the surface of the holding component 3 by sintering. In such a case, a sheet on which the abrasive grains 2 are arrayed to be fixed is disposed on a plate-shaped compact composed of, for example, a metal and oxide, nitride, carbide of the metal or a composite thereof. The abrasive grains are pressed on the compact with a plate and are then sintered at predetermined conditions, namely, the temperature, the pressure, and the time.

As shown in FIGS. 1 and 2, the holding component 3 holding the abrasive grains 2 with a predetermined arrangement is bonded with the base 1 of the dresser with, for example, an epoxy resin. Subsequently, the operating surface of the dresser is planarized and toothed by shot blasting using loose abrasives composed of, for example, alumina and by lapping and etching. The dresser is completed so as to have a predetermined dimension. In addition, the abrasive grains 2 are projected so as to have a predetermined height. Thus, the dresser for a polishing cloth is produced.

### EXAMPLES

Although examples of the present invention will now be described, the present invention is not limited to these examples.

### Example 1

Tungsten carbide (WC) powder and nickel powder (8:2 by weight) were mixed with a ball mill. Paraffin (20 volume percent) was added to the mixed powder and was then further mixed. The resultant mixed powder was filled in a die. A plate-shaped compact was formed with a pressure of 50 MPa. Meanwhile, an adhesive sheet having an adhesive thereon was prepared. Masking was performed on the adhesive sheet as follows: A plurality of holes having the same dimension as that of abrasive grains was formed on the adhesive sheet at a two-dimensionally even interval. Thus, non-masking portions were formed on the adhesive sheet. Adhesive portions formed as the non-masking portions had a diameter of about 270 μm. Regarding the arrangement of the adhesive portions, the minimum grid formed by adjacent abrasive grains in the circumferential direction and in the radial direction fixed on a base (see FIG. 1) formed a parallelogram. The adhesive portions were arrayed such that the abrasive grains were disposed on one side of the parallelogram at an even interval of 0.8 mm.

Subsequently, abrasive grains composed of diamond coated with titanium (30%) were prepared. The abrasive grains were classified so as to have a diameter of 150 to 250 μm. The abrasive grains were adhered to be fixed on the non-masking portions of the adhesive sheet. The sheet was disposed on the above compact composed of the mixed powder of tungsten carbide (WC) and nickel. The abrasive grains were pressed on the compact with a plate. The compact was sintered by hot-pressing at 1,200° C. for one hour under a pressure of 10 MPa to prepare a sintered compact on which the abrasive grains are fixed.

Shot blasting was performed on the dressing surface of the sintered compact using loose abrasives composed of alumina having a grain size of #240. The dressing surface was planarized and toothed such that the projecting height of the diamond abrasive grains from the matrix (sintered compact) was 60 to 80 μm. A cup-shaped base (FIG. 1) composed of a stainless steel (SUS316) and having a diameter of 100 mm was prepared. The sintered compact was bonded on the base so as to have a ring shape having a width of 10 mm with an epoxy resin. Thus, the dresser for a polishing cloth including the sintered compact was produced.

The dresser was pressed with a pressure of 19.6 kPa on a polishing cloth composed of a foamed polyurethane that was rotated at 100 rpm. Potassium hydroxide (KOH)-based alkali slurry (SS25 from Cabot) containing fumed silica as a main component was supplied at a rate of about 15 mL per minute while the dresser was rotated at 50 rpm. Thus, the polishing cloth was ground with the dresser. The dressing rate of the polishing cloth and the surface roughness (Ra and Rz) of the polishing cloth were measured after 1 hour, 2, 3, 5, 10, 15, 20, 25, and 30 hours using ten dressers. The number of dissociated abrasive grains was also counted. Table 1 shows the results.

### Example 2

A plate-shaped compact was formed using tungsten carbide (WC) powder and nickel powder (8:2 by weight) as in Example 1. Masking was performed on an adhesive sheet by forming non-masking portions. Holes having a diameter of about 170 μm and holes having a diameter of about 100 μm, which form the non-masking portions, were arrayed as follows: The minimum grid formed by adjacent abrasive grains in the circumferential direction and in the radial direction formed a parallelogram. The holes having a diameter of 170 μm were arrayed such that abrasive grains were disposed on one side of the parallelogram at an even interval of 0.8 mm. The holes having a diameter of 100 μm were arrayed such that abrasive grains were disposed on one side of the parallelogram at an even interval of 0.4 mm. Abrasive grains were arrayed on the non-masking portions of the adhesive sheet as follows: Non-coated diamond abrasive grains were classified so as to have a diameter of 150 to 170 μm. These abrasive grains were adhered to be fixed on the holes having a diameter of 170 μm. Furthermore, non-coated diamond abrasive grains were classified so as to have a diameter of 55 to 65 μm. These abrasive grains were adhered to be fixed on the holes having a diameter of 100 μm. The resultant sheet was disposed on the compact composed of the mixed powder of tungsten carbide (WC) and nickel. The compact was sintered by hot-pressing as in Example 1 to prepare a sintered compact on which the abrasive grains are fixed.

Shot blasting was performed on the operating surface of the sintered compact using loose abrasives composed of alumina having a grain size of #240. Thus, the projecting height of the diamond abrasive grains having a diameter of 150 to 170 μm from the matrix was controlled to 50 to 60 μm. Subsequently, the top face and the side face of the sintered compact were coated with a halogen-containing diamond like carbon such that the coating had an average thickness of 3 μm. The sintered compact was bonded on the same base as that in Example 1 with an epoxy resin. Thus, the dresser for a polishing cloth was produced.

The dresser was pressed with a pressure of 19.6 kPa on a polishing cloth composed of a foamed polyurethane that was rotated at 100 rpm. Acidic slurry (SS-W2000 from Cabot, pH 2.3) containing 4% H₂O₂ was supplied at a rate of about 15 mL per minute while the dresser was rotated at 50 rpm. Thus, the polishing cloth was ground with the dresser. The dressing rate of the polishing cloth and the surface roughness (Ra and Rz) of the polishing cloth were measured after 1 hour, 2, 3, 5, 10, 15, 20, 25, and 30 hours using ten dressers. The number of dissociated abrasive grains was also counted. Table 1 shows the results.

### Example 3

A mixed powder containing tungsten powder and silicon powder (3:1 by weight) was prepared. Silicon dioxide (5% to the total weight of the mixed powder) was added to the mixed powder. A plate-shaped compact was formed using the resultant powder as in Examples 1 and 2. Masking was performed on an adhesive sheet by forming non-masking portions. The minimum grid formed by adjacent abrasive grains in the circumferential direction and in the radial direction formed a parallelogram. The non-masking portions included holes having a diameter of about 270 μm. The holes were arrayed such that abrasive grains were disposed on one side of the parallelogram at an even interval of 1.5 mm. Non-coated diamond abrasive grains were classified so as to have a diameter of 150 to 250 μm. These abrasive grains were adhered to be fixed on the non-masking portions of the adhesive sheet. The resultant sheet was disposed on the compact composed of the mixed powder of tungsten and silicon. The compact was sintered by hot-pressing as in Examples 1 and 2 to prepare a sintered compact on which the abrasive grains are fixed.

The resultant sintered compact was bonded on the same base as that in Examples 1 and 2 with an epoxy resin. Subsequently, shot blasting was performed on the operating surface using loose abrasives composed of alumina having a grain size of #240. Thus, the projecting height of the diamond abrasive grains from the matrix was controlled to 60 to 80 μm. Thus, the dresser for a polishing cloth was produced.

The dresser was pressed with a pressure of 19.6 kPa on a polishing cloth composed of a foamed polyurethane that was rotated at 100 rpm. Acidic slurry (SS-W2000 from Cabot, pH 2.3) containing 4% H₂O₂ was supplied at a rate of about 15 mL per minute while the dresser was rotated at 50 rpm. Thus, the polishing cloth was ground with the dresser. The dressing rate of the polishing cloth and the surface roughness (Ra and Rz) of the polishing cloth were measured after 1 hour, 2, 3, 5, 10, 15, 20, 25, and 30 hours using ten dressers. The number of dissociated abrasive grains was also counted. Table 1 shows the results.

### Comparative Example

A dresser for a polishing cloth in which diamond abrasive grains having the same dimension as that in Examples 1 to 3 were arrayed at random by fixing by electrocoating was prepared. A polishing cloth composed of a foamed polyurethane was ground as in Example 1 using the above dresser with the KOH-based alkali slurry (SS25 from Cabot) containing fumed silica as a main component. In addition, the number of dissociated abrasive grains was counted as in Examples. The result of the grinding is shown in Table 1 with the results in Examples 1 to 3.

TABLE 1

| | | | | | Com- |
|---|---|---|---|---|---|
| | | | | | parative |
| | | Example 1 | Example 2 | Example 3 | example |
| Dressing rate | Average | 233 | 154 | 240 | 216 |
| of polishing | Standard | 3.25 | 3.41 | 2.85 | 9.86 |
| cloth (μm/h) | deviation | | | | |
| Surface | Average | 6.94 | 4.2 | 6.23 | 4.21 |
| roughness Ra | Standard | 0.06 | 0.12 | 0.22 | 0.41 |
| of polishing | deviation | | | | |
| cloth (μm) | | | | | |
| Surface | Average | 27.42 | 17.84 | 24.12 | 29.55 |
| roughness Rz | Standard | 2.30 | 1.85 | 1.62 | 2.75 |
| of polishing | deviation | | | | |
| cloth (μm) | | | | | |

| | | | | |
|---|---|---|---|---|
| Number of dissociated | 0 | 0 | 0 | 92 |
| abrasive grains during | | | | |
| dressing of polishing | | | | |
| cloth | | | | |

In the dressers for a polishing cloth in Examples, the diamond abrasive grains were disposed with regularity at an even interval. On the other hand, in the dresser for a polishing cloth in Comparative example, the abrasive grains were disposed at random. As shown in Table 1, even when either alkali slurry or acidic slurry was used, the surface roughness of the polishing clothes that were ground with the dressers in Examples was satisfactorily uniform, compared with that in Comparative example. The dressing rate of the polishing clothes that were ground with the dressers in Examples was significantly stable. Furthermore, in the dressers in Examples 1 to 3, no abrasive grain was dissociated.

### BRIEF DESCRIPTION OF THE DRAWINGS

FIG. 1 is perspective view showing a dresser for a polishing cloth according to an embodiment of the present invention.

FIG. 2 is a cross-sectional view of the relevant part of the dresser, cut along a plane parallel to the center of rotation of the dresser.

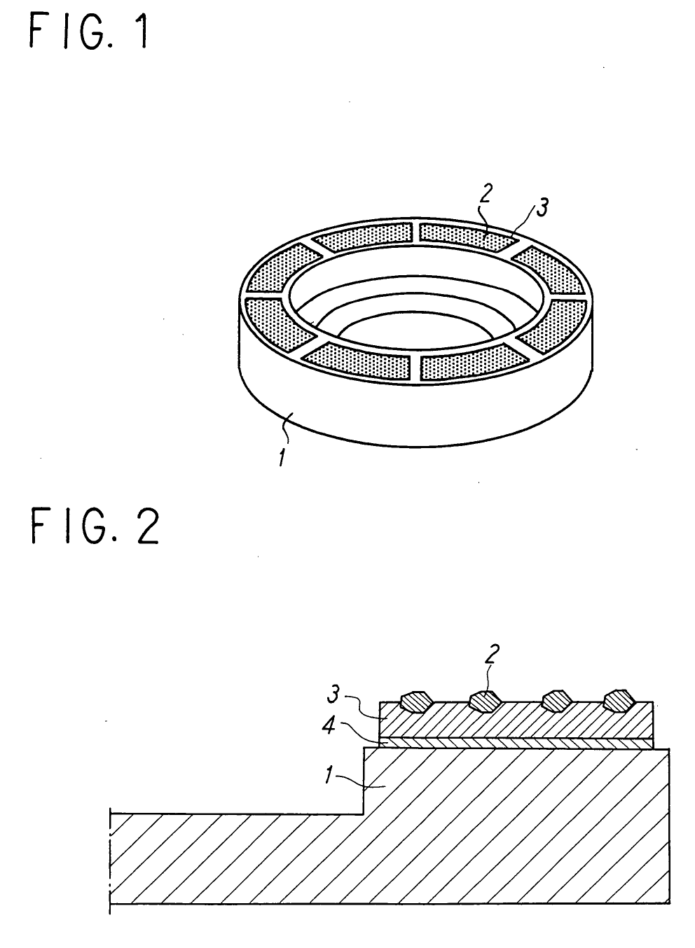

1. A dresser for a polishing cloth comprising a base and a dressing part disposed on the surface of the base,
wherein the dressing part includes a plurality of abrasive grains and a plate-shaped holding component that holds the abrasive grains, and the holding component is mainly composed of cemented carbide or cermet composed of at least one substance having a high melting point and a high hardness selected from a transition metal of IVa, Va, or VIa group of the periodic law, oxide, carbide, nitride, boride, and a composite thereof and at least one metal phase selected from Fe, Co, Ni, Cu, Ti, Cr, and Ag; or a ceramic composed of at least one substance selected from oxide, carbide, nitride, and boride.

2. A dresser for a polishing cloth comprising a base and a dressing part disposed on the surface of the base,
wherein the dressing part includes a plurality of abrasive grains and a plate-shaped holding component that holds the abrasive grains, and the holding component includes silicon serving as a main component; at least one substance serving as a main component selected from a transition metal of IVa, Va, or VIa group of the periodic law, oxide, carbide, nitride, boride, and a composite thereof; and silicon dioxide serving as flux.

3. The dresser for a polishing cloth according to claim 2, wherein the amount of silicon dioxide is 1% to 6% of the weight of the holding component.

4. The dresser for a polishing cloth according to claim 1, wherein the holding component mainly comprises at least one substance selected from a transition metal of IVa, Va, or VIa group of the periodic law, oxide, carbide, nitride, boride, and a composite thereof.

5. The dresser for a polishing cloth according to claim 1, wherein the holding component mainly comprises cemented carbide or cermet composed of at least one substance having a high melting point and a high hardness selected from a transition metal of IVa, IVb, Va, or VIa group of the periodic law, oxide, carbide, nitride, boride, and a composite thereof and at least one metal phase selected from Fe, Co, Ni, Cu, Ti, Cr, and Ag.

6. The dresser for a polishing cloth according to any one of claims 1 to 5, wherein the abrasive grains comprise diamond or cubic boron nitride having a diameter of 10 to 1,000 μm, and the surfaces of the abrasive grains are coated with a substance selected from a transition metal of IVa, IVb, Va, or VIa group; Ni, Co, Ag, and Cu; and a compound thereof or not coated with the substance.

7. The dresser for a polishing cloth according to any one of claims 1 to 5, wherein the plurality of abrasive grains are arrayed on the surface of the holding component with two-dimensional regularity, the distance between the adjacent abrasive grains on the minimum grid formed by the array is in the range of 10 to 3,000 μm, and the abrasive grains are substantially arrayed with an even distribution.

8. The dresser for a polishing cloth according to claim 7, wherein the abrasive grains comprise a group having a predetermined grain size or two or more of groups having different predetermined grain size, and abrasive grains in each group are arrayed with independent regularity.

9. The dresser for a polishing cloth according to any one of claims 1 to 5, wherein an acid and alkali-resistant hard nonmetal film is disposed on the exposed surface of the planar holding component that holds the abrasive grains or on the exposed surfaces of the holding component and the base.

10. The dresser for a polishing cloth according to claim 9, wherein the acid and alkali-resistant nonmetal film has a thickness of 1 to 10 μm.

11. The dresser for a polishing cloth according to claim 9, wherein the acid and alkali-resistant nonmetal film comprises a halogen-containing diamond like carbon or diamond like carbon.

12. A method for producing the dresser for a polishing cloth according to claim 1 comprising:
a step of forming adhesive portions having almost the same diameter as that of abrasive grains at positions corresponding to holding positions of the abrasive grains to be arrayed with two-dimensional regularity, the positions being disposed on the surface of a holding component or a sheet disposed on the holding component, in order that the plurality of the abrasive grains are held on the surface of the holding component with regularity;
adhering each single particle of the abrasive grains on the adhesive portions;
holding the abrasive grains on the surface of the holding component; and sintering the holding component to fix the abrasive grains.

13. A method for producing the dresser for a polishing cloth according to claim 2 comprising:
a step of forming adhesive portions having almost the same diameter as that of abrasive grains at positions corresponding to holding positions of the abrasive grains to be arrayed with two-dimensional regularity, the positions being disposed on the surface of a holding component or a sheet disposed on the holding component, in order that the plurality of the abrasive grains are held on the surface of the holding component with regularity;
adhering each single particle of the abrasive grains on the adhesive portions;
holding the abrasive grains on the surface of the holding component; and sintering the holding component to fix the abrasive grains.

14. The method for producing a dresser for a polishing cloth according to claim 12 or claim 13, wherein the surfaces of the abrasive grains are coated with a substance selected from a transition metal of IVa, IVb, Va, or VIa group; Ni, Co, Ag, and Cu; and a compound thereof.

15. The method for producing a dresser for a polishing cloth according to claim 12 or claim 13, wherein the step of forming the adhesive portions having almost the same diameter as that of the abrasive grains comprises a step of forming non-masking portions serving as the adhesive portions on a sheet that masks the surface of the holding component having an adhesive thereon by forming holes having almost the same diameter as that of the abrasive grains.
